(19) United States
(12) Patent Application Publication
(10) Pub. No.: US 2019/0261440 A1
(43) Pub. Date: Aug. 22, 2019

(54) ELECTRONIC DEVICE AND WIRELESS CONNECTION CONTROL METHOD OF ELECTRONIC DEVICE

(71) Applicant: SAMSUNG ELECTRONICS CO., LTD., Suwon-si (KR)

(72) Inventors: Byung Keuk LIM, Suwon-si (KR); Je Ik KIM, Yongin-si (KR)

(73) Assignee: SAMSUNG ELECTRONICS CO., LTD., Suwon-si (KR)

(21) Appl. No.: 16/347,248

(22) PCT Filed: Oct. 18, 2017
(86) PCT No.: PCT/KR2017/011547

§ 371 Date: May 3, 2019

(30) Foreign Application Priority Data
Nov. 3, 2016 (KR) 10-2016-0145544

(51) Int. Cl. H04W 76/14; H04W 72/04

(52) U.S. Cl. CPC H04W 76/14; H04W 88/06; H04W 72/0453

(57) ABSTRACT

An electronic device includes a first communication module for performing communication with an access point (AP), a second communication module for performing communication with an external electronic device, and a control module for controlling the second communication module to determine a frequency used for communication with the external device, depending on a frequency used for communication with the AP by the first communication module.

### TECHNICAL FIELD

The disclosure relates to an electronic device for connecting with an external electronic device using a frequency of a DFS restricted band and a method for controlling a wireless connection in the electronic device.

### BACKGROUND ART

In a wireless network environment, electronic devices such as smartphones and notebooks may access the Internet via an access point (AP). The electronic devices may be connected to the AP over wireless-fidelity (Wi-Fi). A plurality of electronic devices connected to the AP may be connected with each other via the AP.

Recently, the plurality of electronic devices may be connected with each other in a peer-to-peer (P2P) mode without passing through an AP to directly transmit data. The electronic device may be directly connected with another electronic device in the P2P mode in a state where it is connected with an AP.

A wireless local area network (WLAN) for connecting electronic devices in a short range may configure a wireless network according to the IEEE 802. 11 standard. The WLAN may use a signal of a frequency band of 2.4 to 2.5 GHz and 5 GHz available without permission for communication. In a connection between electronic devices or a connection between the electronic device and an AP, a channel of a band of 2.4 to 2.5 GHz and 5 GHz may be used.

### DISCLOSURE

### Technical Problem

Because a frequency band of 5 GHz has a wider frequency band than a frequency band of 2.4 GHz and is relatively less in wireless interference than the frequency band of 2.4 GHz, there is an increase in performing wireless communication using a channel of the frequency band of 5 GHz. Because the frequency band of 5 GHz includes a restricted frequency band used in a radar for military purposes or the like, an electronic device should have DFS and TPC functions capable of avoiding interference of a signal to use the restricted frequency band.

When an AP has the DFS and TPC functions, an electronic device connected to the AP does not need to have the DFS and TPC functions independently. When electronic devices are directly connected with each other in a P2P mode without passing through the AP, they should have the DFS and TPC functions independently.

Various embodiments of the disclosure are to provide an electronic device for connecting with another electronic device in a P2P mode using a frequency band of 5 GHz although it does not has DFS and TPC functions independently in a connection between a plurality of electronic devices and a method for controlling a wireless connection in the electronic device.

### Technical Solution

In accordance with an aspect of the disclosure, an electronic device is provided. The electronic device may include a first communication module configured to perform communication with an access point (AP), a second communication module configured to perform communication with an external electronic device, and a control module configured to control the second communication module to determine a frequency used for communication with the external device, depending on a frequency used for communication with the AP by the first communication module.

In accordance with another aspect of the disclosure, a method for controlling a wireless connection in an electronic device is provided. The method may include connecting with an access point (AP) via a first communication module, identifying a frequency used for communication with the AP by the first communication module, and connecting with an external electronic device using the identified frequency via a second communication module.

In accordance with another aspect of the disclosure, a computer-readable storage medium is provided. The computer-readable storage medium may perform a method including connecting with an access point (AP) via a first communication module, identifying a frequency used for communication with the AP by the first communication module, and connecting with an external electronic device using the identified frequency via a second communication module.

### Advantageous Effects

An electronic device of the disclosure and a method for controlling a wireless connection in the electronic device may identify a channel used by an AP having a DFS function and may use the channel when connected with another electronic device to use a channel of a DFS restricted band although the electronic device does not independently have a module necessary to have the DFS function.

Furthermore, the electronic device may use a channel of the same DFS restricted band when communicating with an AP and another electronic device to transmit and receive a signal with the AP and the other electronic device without switching.

### DESCRIPTION OF DRAWINGS

FIG. 1 is a drawing illustrating a network system according to various embodiments of the disclosure;

FIG. 2 is a drawing illustrating a channel of a frequency band of 5 GHz used by an access point (AP) according to an embodiment of disclosure;

FIG. 3 is a block diagram illustrating a configuration of a first electronic device according to an embodiment of the disclosure;

FIG. 4 is a block diagram illustrating a configuration of a second electronic device according to an embodiment of the disclosure;

FIGS. 5A, 5B, and 5C are drawings illustrating a connection among an AP, a first electronic device, and a second electronic device according to an embodiment of the disclosure; and

FIGS. 6 and 7 are flowcharts illustrating a method for controlling a wireless connection in a first electronic device according to an embodiment of the disclosure.

### MODE FOR INVENTION

Hereinafter, various embodiments of the disclosure will be described with reference to the accompanying drawings.

Embodiments of the disclosure are provided to more fully describe the disclosure to those skilled in the art. Embodiments below may be modified in various different forms, and the scope of the disclosure is not limited to the embodiments below. Rather, these embodiments are provided to more faithfully and fully deliver the disclosure and fully deliver the spirit of the disclosure to those skilled in the art.

Terms used in the disclosure are used to describe specified embodiments and are not intended to limit the scope of the disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of the disclosure. In some cases, even if terms are terms which are defined in the disclosure, they may not be interpreted to exclude embodiments of the disclosure.

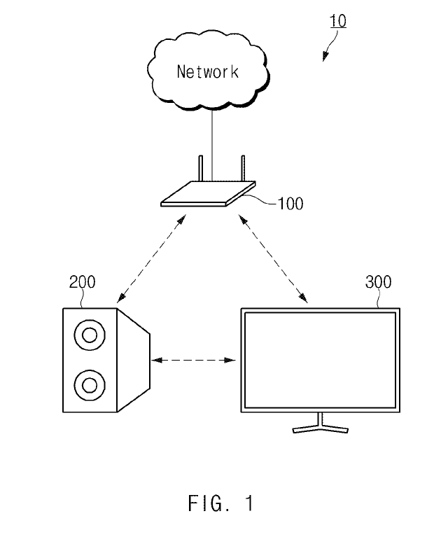

FIG. 1 is a drawing illustrating a network system according to various embodiments of the disclosure.

Referring to FIG. 1, a network system 10 may include an access point (AP) 100, a first electronic device 200, and a second electronic device 300.

The AP 100 may be connected to a network in a wired manner. For example, the AP 100 may be connected to the network via a wide area network (WAN) port or a local area network (LAN) port. The network may be, for example, the Internet. An internet service provider (ISP) may be connected to the AP 100 via the port. Thus, an electronic device connected to the AP 100 may be assigned an internet protocol (IP) to be connected to the Internet.

According to an embodiment, the AP 100 may be connected with the electronic device 200 or 300, and the electronic device 200 or 300 may access the network. For example, the AP 100 may be wirelessly connected with the electronic device 200 or 300 to transmit data provided from the network. The AP 100 may be connected with the electronic device 200 or 300 in a wireless-fidelity (Wi-Fi) mode. For another example, the AP 100 may transmit data, received from the electronic device 200 or 300, to a corresponding destination of the network over a router connected in a wired manner. The network may be, for example, the Internet.

According to an embodiment, the AP 100 may wirelessly communicate with the electronic device 200 or 300 using a frequency band of 5 GHz. The AP 100 may wirelessly communicate with the electronic device 200 or 300 using a channel of the frequency band of 5 GHz.

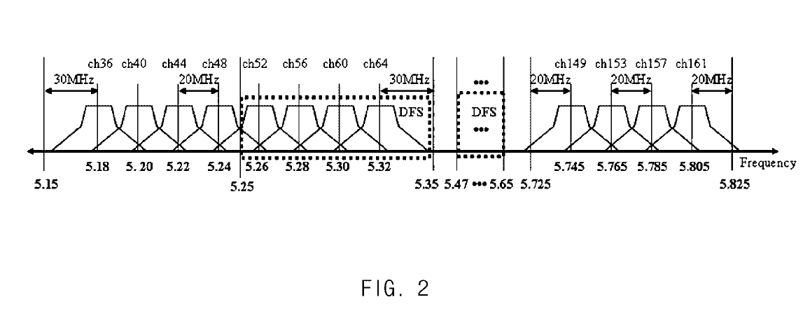

FIG. 2 is a drawing illustrating a channel of a frequency band of 5 GHz used by an access point (AP) according to an embodiment of disclosure.

Referring to FIG. 2, the frequency band of 5 GHz has a total of 200 channel numbers at intervals 5 MHz. According to according to the IEEE 802.11a specification, an interval between center frequencies of respective channels of the frequency band of 5 GHz is 20 MHz. Thus, a channel number used in a wireless LAN is increased at intervals of 4, and each country is assigned different channels among the 200 channel numbers to use them. For example, a total of 19 channels having channel numbers 36, 40, 44, 48, 52, 56, 60, 64, 100, 104, 108, 112, 116, 120, 124, 149, 153, 157, and 161 are domestically used.

According to an embodiment, as the frequency band of 5 GHz is used in a radar for military purposes, weather forecasting, navigation, satellite, or the like, there is a predetermined restriction on using a part of the frequency band of 5 GHz. A frequency band having a restriction on being used in the frequency band of 5 GHz may be a DFS restricted band. To communicate using a channel of the DFS restricted band, an electronic device should have DFS and TPC functions. Each country may determine a standard of the DFS restricted band. For example, 5,25 GHz to 5.35 GHz (channels 52, 56, 60, and 64) and 5.47 GHz to 5.65 GHz (channels 100, 104, 108, 112, 116, 120, and 124) are domestically designated as the DFS restricted band, and the electronic device should have the DFS and TPC functions to use the frequency band.

The DFS function is a function capable of detecting a channel used in the radar and connecting with an external electronic device using a channel which is not used in the radar. The TPC function is a function of setting a maximum transmit power or request to reduce a transmit power and transmitting a signal at a power of less than or equal to the maximum transmit power or reducing and transmitting the transmit power, when the connected electronic device transmits the signal.

Table 1 below denotes a DFS restricted channel limited in the federal communications commission (FCC) in the United States.

TABLE 1

| Channel | Frequency | US & Can | Band |
|---|---|---|---|
| 36 | 5180 | Indoors | UNII-1 |
| 40 | 5200 | Indoors | UNII-1 |
| 44 | 5220 | Indoors | UNII-1 |
| 48 | 5240 | Indoors | UNII-1 |
| 52 | 5260 | DFS | UNII-2 |
| 56 | 5280 | DFS | UNII-2 |
| 60 | 5300 | DFS | UNII-2 |
| 64 | 5320 | DFS | UNII-2 |
| 100 | 5500 | DFS | UNII-2e |
| 104 | 5520 | DFS | UNII-2e |
| 108 | 5540 | DFS | UNII-2e |
| 112 | 5560 | DFS | UNII-2e |
| 116 | 5580 | DFS | UNII-2e |
| 132 | 5660 | DFS | UNII-2e |
| 136 | 5680 | DFS | UNII-2e |
| 140 | 5700 | DFS | UNII-2e |
| 149 | 5745 | Yes | UNII-3(ISM) |
| 153 | 5765 | Yes | UNII-3(ISM) |
| 157 | 5785 | Yes | UNII-3(ISM) |
| 161 | 5805 | Yes | UNII-3(ISM) |
| 165 | 5825 | Yes | UNII-3(ISM) |

According to an embodiment, an AP 100 of FIG. 1 may include the DFS and TPC functions to communicate using a frequency (or channel) of the DFS restricted channel. The AP 100 may include a DFS frequency control module and a TPS power control module independently to have the DFS and TPC functions.

The DFS frequency control module may avoid a frequency which is in use by an external electronic device in a specified frequency band to use another frequency. For example, the specified frequency band may be a DFS restricted band. The DFS frequency control module may include an antenna for detecting a frequency used by the radar. For example, when the DFS frequency control module wants to use a frequency of the DFS restricted band, it may determine whether there is a radar which is using a frequency to be used above 60 seconds. Although the DFS frequency control module is using a frequency of the DFS restricted band, when a radar which is using the frequency is detected, the DFS frequency control module may move to another frequency within 10 seconds. The DFS frequency control module is unable to use a frequency detected in use by the radar again during 30 minutes.

The TPS power control module may limit a transmit power of an electronic device 200 or 300 connected with the AP 100. For example, the TPS power control module may set a maximum transmit power and may limit the electronic device 200 or 300 to transmitting a signal at less than or equal to the maximum transmit power. For another example, the TPS power control module may requests the electronic device 200 or 300 to reduce a transmit power and may refrain from reducing the transmit power within a range capable of maintaining a connection.

The first electronic device 200 may be connected to the AP 100 to access a network. For example, the first electronic device 200 may be wirelessly connected to receive data provided to the network. The first electronic device 200 may transmit data to a desired destination via the AP 100. The first electronic device 200 may be connected with the AP 100 in a Wi-Fi mode.

According to an embodiment, the first electronic device 200 may be wirelessly connected with the second electronic device 300. For example, the first electronic device 200 may be directly connected with the second electronic device 300 in a peer-to-peer (P2P) mode using the Wi-Fi mode. Thus, the first electronic device 200 may transmit data to the second electronic device 300 without passing through the AP 100 or may receive data from the second electronic device 300.

According to an embodiment, the first electronic device 200 may process data received via the AP 100 or may process data received from an external electronic device (e.g., an external electronic device of a network system 10). For example, the first electronic device 200 may receive an audio signal from the second electronic device 300 or may output the received audio signal. The first electronic device 200 may be a device capable of receiving and outputting an audio signal from an external device, for example, a smartphone, a tablet PC, or a speaker.

The second electronic device 300 may be connected to the AP 100 to access the network. For example, the second electronic device 300 may be wirelessly connected to receive data provided to the network. The second electronic device 300 may transmit data to the desired destination via the AP 100. The second electronic device 300 may be connected with the AP 100 over Wi-Fi.

According to an embodiment, the second electronic device 300 may be wirelessly connected with the first electronic device 200. For example, the second electronic device 300 may be directly connected with the first electronic device 200 in the P2P mode using the Wi-Fi mode. Thus, the second electronic device 300 may transmit data to the first electronic device 200 without passing through the AP 100 or may receive data from the first electronic device 200.

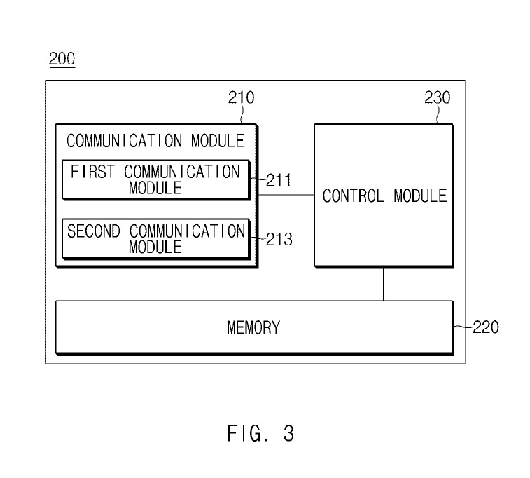

According to an embodiment, the second electronic device 300 may process data received via the AP 100. For example, the second electronic device 300 may display an image included in a signal received from the external device on its display. According to an embodiment, the second electronic device 300 may transmit data to the first electronic device 200. For example, the second electronic device 300 may transmit an audio signal to the external electronic device. The second electronic device 300 may be, for example, a TV, a desktop, a notebook PC, a smartphone, a tablet PC, or the like. FIG. 3 is a block diagram illustrating a configuration of a first electronic device according to an embodiment of the disclosure.

A first electronic device 200 may include a communication module 210, a memory 220, and a control module 230.

The communication module 210 may include a first communication module 211 and a second communication module 213. For example, the communication module 210 may include an antenna, an RF transmit module for up-converting and amplifying a frequency of a transmitted signal, an RF receive module for performing low noise amplification of a received signal to down-convert a frequency of the received signal, a modulation/demodulation module of an RF signal, a signal processing module, or the like.

The first communication module 211 may be wirelessly connected with an AP 100. The first communication module 211 may be a Wi-Fi module. For example, the first communication module 211 may communicate with the AP 100 using a frequency (or channel) of a DFS restricted band.

The second communication module 213 may be wirelessly connected with a second electronic device 300. The second communication module 213 may be a Wi-Fi module. The first electronic device 200 may be directly connected with the second electronic device 300 in a P2P mode. For example, the second communication module 213 may communicate with the AP 100 and the second electronic device 300 using the frequency of the DFS restricted band.

For example, the first communication module 211 and the second communication module 213 may be configured with the same Wi-Fi module. The first communication module 211 and the second communication module 213 may be implemented as the one communication module 210. The first communication module 211 and the second communication module 213 may use the same frequency to be connected to the AP 100 and the second electronic device 300, respectively.

The memory 220 may store various control programs of the control module 230, an application program, or the like and may store a variety of information for controlling the communication module 210. For example, the memory 200 may include at least one of a read only memory (ROM) and a random access memory (RAM).

The control module 230 may control an overall operation of the first electronic device 200. The control module 230 may control the communication module 210 and the memory 220 and may be electrically connected with the AP 100 and the second electronic device 300.

According to an embodiment, the control module 230 may fail to include a DFS frequency control module independently to be different from the AP 100. For example, the control module 230 may fail to include an antenna for detecting a frequency which is in use by an external device. The control module 230 may set the first communication module 211 to communicate using a frequency selected by the AP 100 including a DFS frequency control module. The control module 230 may set the second communication module 213 to communicate using a frequency selected by the second electronic device 300 connected with the AP 100 including the DFS frequency control module. Thus, the first electronic device 200 may use a frequency of a DFS restricted band without separately including the DFS frequency control module.

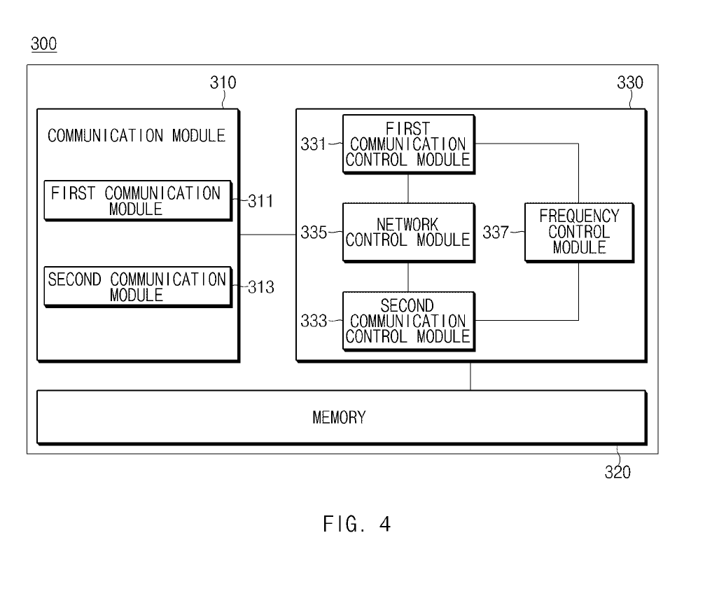

FIG. 4 is a block diagram illustrating a configuration of a second electronic device according to an embodiment of the disclosure.

A second electronic device 300 may include a communication module 310, a memory 320, and a control module 330.

The communication module 310 may include a first communication module 311 and a second communication module 313. For example, the communication module 310 may include an antenna, an RF transmit module for up-converting and amplifying a frequency of a transmitted signal, an RF receive module for performing low noise amplification of a received signal to down-convert a frequency, a modulation/demodulation module of an RF signal, a signal processing module, or the like.

The first communication module 311 may be wirelessly connected with an AP 100. The first communication module 311 may be a Wi-Fi module. For example, the first communication module 311 may communicate with the AP 100 using a frequency (or channel) of a DFS restricted band.

The second communication module 313 may be wirelessly connected with a first electronic device (or an external electronic device) 200. The second communication module 313 may be a Wi-Fi module. The second electronic device 300 may be directly connected with the first electronic device 200 in a P2P mode. The second communication module 313 may be directly connected with the first electronic device 200 using Wi-Fi direct, Ad-hoc, and tunneled direct link setup (TLDS). For example, the second communication module 313 may communicate with the AP 100 and the first electronic device 200 using the frequency of the DFS restricted band.

For example, the first communication module 311 and the second communication module 313 may be configured with the same Wi-Fi module. The first communication module 311 and the second communication module 313 may be implemented as the one communication module 310. The first communication module 311 and the second communication module 313 may use the same frequency to be connected to the AP 100 and the first electronic device 200, respectively. When the first communication module 311 and the second communication module 313 use different frequencies, the communication module 310 may need switching for transmitting and receiving signals of different frequencies. The switching may be, for example, switching for selecting an antenna which transmits and receives signals of different frequencies. Thus, when the first communication module 311 and the second communication module 313 use the same frequency, the communication module 310 may simultaneously communicate with the AP 100 and the first electronic device 200 without the switching.

The memory 320 may store various control programs of the control module 230, an application program, or the like and may store a variety of information for controlling the communication module 310. For example, the memory 320 may include at least one of a read only memory (ROM) and a random access memory (RAM).

According to an embodiment, the memory 320 may store information delivered from the communication module 310 in the RAM. For example, the memory 320 may store connection configuration information for connecting with the AP 100.

The control module 330 may control an overall operation of the second electronic device 300. The control module 330 may control the communication module 310 and the memory 320 and may be electrically connected with the AP 100 and the first electronic device 200.

According to an embodiment, the control module 330 may include a first communication control module 331, a second communication control module 333, a network control module 335, and a frequency control module 337. The control module 330 may control the second communication module 313 to change a frequency used for communication with the second electronic device 300, depending on a frequency used for communication with the AP 100 by the first communication module 311. For example, when the frequency used for the communication with the AP 100 by the first communication module 311 is changed, the control module 330 may control to change a frequency used for communication with the external electronic device 200 by the second communication module 313.

The first communication control module 331 may control the first communication module 311 to be connected with the AP 100. According to an embodiment, the first communication control module 331 may transmit and receive connection configuration information via the network control module 335 to configure a connection between the AP 100 and the first communication module 311. The connection configuration information may include connection request information for being connected with the AP 100 and frequency information. For example, when receiving the connection request information, the first communication control module 331 may configure a frequency (or channel) for communication with the first communication module 311. According to an embodiment, the frequency information used for a connection with the AP 100 by the first communication control module 331 may be transmitted to the frequency control module 337.

The second communication control module 333 may control the second communication module 313 to be connected with the first electronic device 200. According to an embodiment, the second communication control module 333 may transmit and receive connection configuration information via the network control module 335 to configure a connection between the second communication module 313 and the first electronic device 200. The connection configuration information may include connection request information for being connected with the first electronic device 200. For example, when receiving the connection request information, the second communication control module 333 may configure a frequency for communication of the second communication module 313. According to an embodiment, the second communication control module 333 may receive frequency information from the frequency control module 337 and may control such that the second communication module 313 is connected with the first electronic device 200 using the frequency.

The network control module 335 may receive connection configuration information for connecting the AP 100 and the first electronic device 200. The network control module 331 may receive the connection configuration information input via the communication module 310 and may transmit the received connection configuration information to the first communication control module 331 and the second communication control module 333.

The frequency control module 337 may identify a frequency (or channel) used to communicate by the first communication module 311. For example, the frequency control module 337 may receive frequency information used to communicate with the AP 100 by the first communication module 311 and may identify the used frequency. The frequency control module 337 may store, for example, the received frequency information in the memory 320.

According to an embodiment, the frequency control module 337 may transmit the identified frequency information to the second communication control module 333. For example, the frequency control module 337 may transmit information about the identified frequency stored in the memory 320 to the second communication control module 333. The specified frequency band may be, for example, a DFS restricted band. Thus, the second communication control module 333 may be connected with the first electronic device 200 with a frequency of the specified frequency band using the received frequency information.

According to an embodiment, the control module 330 may fail to include a DFS frequency control module separately to be different from an AP 100 of FIG. 1. For example, the control module 330 may fail to include an antenna for detecting a frequency which is in use by an external device. The control module 330 may set the first communication module 311 to communicate using a frequency selected by the AP 100 including the DFS frequency control module. The control module 330 may control the second communication module 313 to change a frequency used for communication with the first electronic device 200, depending on a frequency used to be connected with the AP 100 including the DFS frequency control module. Thus, the second electronic device 300 may use a frequency of the DFS restricted band without separately including the DFS frequency control module.

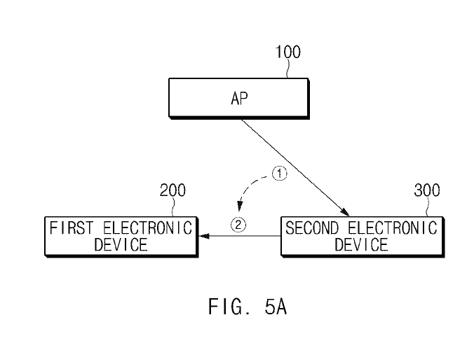

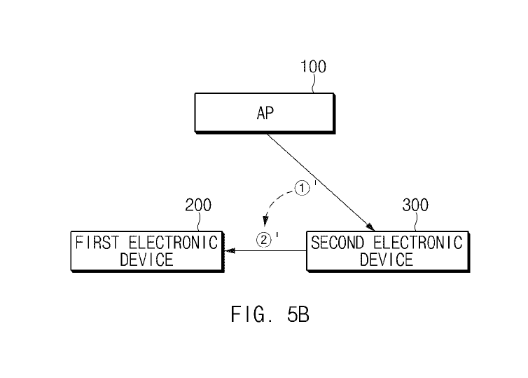

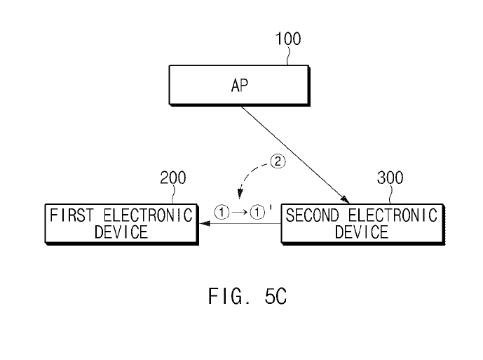

FIGS. 5A to 5C are drawings illustrating a connection among an AP, a first electronic device, and a second electronic device according to an embodiment of the disclosure.

Referring to FIG. 5A, an AP 100 and a second electronic device 300 may first be connected with each other, and a first electronic device 200 may be connected to the second electronic device 300.

The second electronic device 300 may receive connection configuration information from the AP 100 via a network control module 335 and may be connected with the AP 100 (\textcircled{1}). A first communication control module 331 may configure a frequency (or channel) for communication of a first communication module 311 using frequency information included in the received connection configuration information. A frequency included in the frequency information may be a frequency of a DFS restricted band. The frequency may be a frequency selected because the use of a radar (e.g., for military purposes, for weather forecasting, for navigation, for satellite, or the like) is not detected by a DFS frequency control module of the AP 100.

The second electronic device 300 may be connected with the AP 100, and the second electronic device 300 may receive connection request information from the first electronic device 200 via the network control module 331 and be connected with the first electronic device 200 (\textcircled{2}). When the second communication control module 333 receives the connection request information, a frequency control module 337 may identify a frequency used to be connected with the AP 100 from the first communication control module 331. The frequency control module 337 may transmit information about the identified frequency to the second communication control module 333. The specified frequency band may be the DFS restricted band. The second communication control module 333 may transmit connection configuration information including the frequency information to the first electronic device 200 to be connected with the first electronic device 200 using the frequency.

Referring to FIG. 5B, the second electronic device 300 may be connected to the AP 100 and the first electronic device 200, and the AP 200 may detect a frequency (or channel) which is in use by a radar.

The second electronic device 300 may be connected using a frequency which is not used by the radar through the process, and, when a DFS frequency control module of the AP 100 detects use by the radar (e.g., for military purposes, for weather forecasting, for navigation, for satellite, or the like) at the frequency, the AP 100 may change the frequency to be connected with the first electronic device 200 (\textcircled{1}′). When the second electronic device 300 receives frequency information from the AP 100, the frequency control module 337 may identify a frequency used for a connection with the AP 100 from the first communication control module 331. The frequency control module 337 may transmit information about the identified frequency to the second communication control module 333. The specified frequency band may be the DFS restricted band. The second communication control module 333 may transmit connection configuration information including the frequency information to the first electronic device 200 and may connect a frequency used for communication with the first electronic device 200 to the changed channel (\textcircled{2}′). A frequency included in the frequency band may be a frequency of the DFS restricted band. The frequency may be a frequency selected because the use of the radar (e.g., for military purposes, for weather forecasting, for navigation, for satellite, or the like) is not detected by the DFS frequency control module of the AP 100.

Referring to FIG. 5C, the second electronic device 300 may first be connected with the first electronic device 200, and the AP 100 may be connected to the second electronic device 300.

The second electronic device 300 may receive connection request information from the first electronic device 200 via the network control module 331 to be connected with the first electronic device 200 (\textcircled{1}). When the second communication control module 333 receives the connection request information, the first communication control module 331 may establish a frequency (or channel) for communicating with the first electronic device 200. The frequency may fail to be a frequency of the DFS restricted band.

The second electronic device 300 may be connected with the first electronic device 200, and the first electronic device 200 may receive connection configuration information from the AP 100 via the network control module 331 to be connected with the AP 100 (\textcircled{2}). When the second electronic device 300 receives connection configuration information including frequency information from the AP 100, the frequency control module 337 may identify a frequency used to be connected with the AP 100 from the first communication control module 331. The frequency control module 337 may transmit information about the identified frequency to the second communication control module 333. The second communication control module 333 may transmit the connection configuration information including the frequency information to the first electronic device 200 to be connected with the first electronic device 200 again using the frequency (\textcircled{1}′). A frequency included in the frequency information may be a frequency of the DFS restricted band. The frequency may be a frequency selected because the use of the radar (e.g., for military purposes, for weather forecasting, for navigation, for satellite, or the like) is not detected by the DFS frequency control module 321 of the AP 100.

Thus, the second electronic device 300 may be connected with the first electronic device 200 using the frequency of the DFS restricted band, which is not detected in use by an external electronic device (e.g., the radar for military purposes, navigation, or the like).

According to various embodiments of the disclosure described with reference to FIGS. 1 to 5C, the second electronic device 300 may identify a frequency used by the AP 100 having a DFS function and may use the frequency when connected with the first electronic device 200 to use the frequency of the DFS restricted band although it does not independently have a module necessary to have the DFS function.

Furthermore, the second electronic device 300 may use a frequency of the same DFS restricted band when communicating with the AP 100 and the first electronic device 200 to transmit and receive a signal with the AP 100 and the first electronic device 200 without switching.

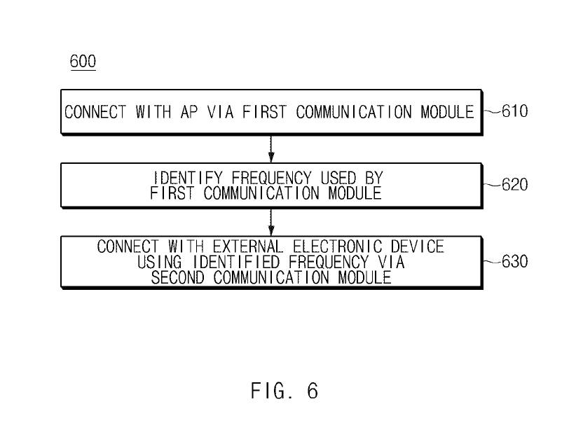

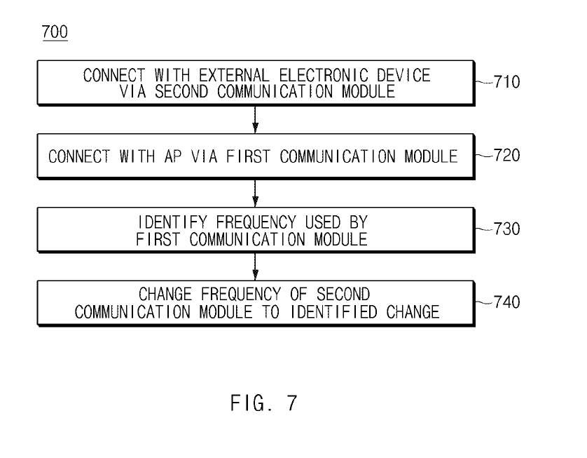

FIGS. 6 and 7 are flowcharts illustrating a method for controlling a wireless connection in a first electronic device according to an embodiment of the disclosure.

The flowcharts shown in FIGS. 6 and 7 may be configured with operations processed in the above-mentioned second electronic device 300. Thus, although there are details omitted below, details described about an electronic device with reference to FIGS. 1 to 5C may also applicable to the flowchart shown in FIG. 6.

Referring to FIG. 6, in a method 600 for controlling a wireless connection in an electronic device, an AP 100 and the second electronic device 300 may be connected with each other, and a first electronic device 200 may be connected to the second electronic device 300.

According to an embodiment, in operation 610, the second electronic device 300 may be connected with the AP 100 via a first communication module 311. The AP 100 may include a DFS frequency control module, and the second electronic device 300 may use a frequency (or channel) which is not detected in use by an external electronic device (e.g., a radar for military purposes, navigation, or the like) in a specified frequency band for connection of the first communication module 311 to be connected with the AP 100. The specified frequency band may be a DFS restricted band.

According to an embodiment, in operation 620, the second electronic device 300 may identify a frequency used for communication with the AP 100 by the first communication module 311. In the operation of identifying the frequency used by the first communication module 311, when connection request information is received from the first electronic device 200, a frequency control module 337 of the second electronic device 300 may receive frequency information used by the first communication module and may identify the frequency used by the first communication module 311.

According to an embodiment, in operation 630, the second electronic device 300 may be connected with the first electronic device 200 using the identified frequency via a second communication module 313. The frequency control module 337 may transmit information about the identified frequency to the second communication module 333, and the second communication control module 333 may connect the second communication module 313 using a frequency included in the frequency.

Thus, the second electronic device 300 may be connected with the first electronic device 200 using a frequency of the DFS restricted band, which is not detected in use by the external electronic device (e.g., a radar for military purposes, navigation, or the like).

Referring to FIG. 7, in a method 700 for controlling a wireless connection in an electronic device, the second electronic device 300 and the first electronic device 200 may be connected with each other, and the AP 100 may be connected to the second electronic device 300.

According to an embodiment, in operation 710, the second electronic device 300 may be connected with the first electronic device 200 via the second communication module 313. The second electronic device 300 may fail to include a DFS frequency control module 321 for avoiding a frequency (or channel) which is in use by the external electronic device (e.g., the radar for military purposes, navigation, or the like) and may be connected with the first electronic device 200 without using a frequency of a specified frequency band. The specified frequency band may be the DFS restricted band.

According to an embodiment, in operation 720, the second electronic device 300 may be connected with the AP 100 via the first communication module 311. The AP 100 may include the DFS frequency control module 321, and the second electronic device 300 may use a frequency which is not detected in use by the external electronic device (e.g., the radar for military purposes, navigation, or the like) in the specified frequency band for a connection of the first communication module 311 to be connected with the AP 100. The specified frequency band may be the DFS restricted band.

According to an embodiment, in operation 730, the second electronic device 300 may identify a frequency used for communication by the first communication module 331. When the second communication control module 333 receives frequency information for a connection with the AP 100, the frequency control module 337 of the second electronic device 300 may receive frequency information used by the first communication module 311 and may identify the used frequency.

According to an embodiment, in operation 740, the second electronic device 300 may change a frequency of the second communication module 313 to the identified frequency. The frequency control module 337 may transmit information about the identified frequency to the second communication control module 333, and the second communication control module 333 may transmit connection configuration information including the frequency information to the first electronic device 200 to be connected with the first electronic device 200 again using the frequency.

Thus, the second electronic device 300 may be connected with the first electronic device 200 using the frequency of the DFS restricted band, which is not detected in use by the external electronic device (e.g., the radar for military purposes, navigation, or the like).

The term “module” used in the disclosure may represent, for example, a unit including one or more combinations of hardware, software and firmware. The term “module” may be interchangeably used with the terms “unit”, “logic”, “logical block”, “part” and “circuit”. The “module” may be a minimum unit of an integrated part or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in a computer-readable storage media in the form of a program module. The instruction, when executed by a processor (e.g., the processor), may cause the one or more processors to perform a function corresponding to the instruction. The computer-readable storage media, for example, may be the memory.

A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and hardware devices (e.g., a read only memory (ROM), a random access memory (RAM), or a flash memory). Also, the one or more instructions may contain a code made by a compiler or a code executable by an interpreter. The above hardware unit may be configured to operate via one or more software modules for performing an operation according to various embodiments, and vice versa.

A module or a program module according to various embodiments may include at least one of the above components, or a part of the above components may be omitted, or additional other components may be further included. Operations performed by a module, a program module, or other components according to various embodiments may be executed sequentially, in parallel, repeatedly, or in a heuristic method. In addition, some operations may be executed in different sequences or may be omitted. Alternatively, other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

1. An electronic device, comprising:
a first communication module configured to perform communication with an access point (AP);
a second communication module configured to perform communication with an external electronic device; and
a control module configured to control the second communication module to determine a frequency used for communication with the external device, depending on a frequency used for communication with the AP by the first communication module.

2. The electronic device of claim 1, wherein the AP includes a dynamic frequency selection (DFS) function, and
wherein the frequency used for the communication with the AP by the first communication module is a frequency of a DFS restricted band.

3. The electronic device of claim 1, wherein the control module is configured to:
when the frequency used for the communication with the AP by the first communication module is changed, change a frequency used for communication of the external electronic device by the second communication module depending on the changed frequency.

4. The electronic device of claim 1, wherein the first communication module is a wireless-fidelity (Wi-Fi) module.

5. The electronic device of claim 1, wherein the second communication module is a Wi-Fi module, and
wherein the Wi-Fi module is configured to be connected with the external electronic device using at least one of Wi-Fi, Ad-hoc, and tunneled direct link setup (TDLS).

6. The electronic device of claim 1, further comprising:
a display,
wherein the external electronic device is an audio output device configured to output an audio signal, and
wherein the control module is configured to:
display an image on the display; and
transmit an audio signal to the external electronic device via the second communication module.

7. A method for controlling a wireless connection in an electronic device, the method comprising:
connecting with an access point (AP) via a first communication module;
identifying a frequency used for communication with the AP by the first communication module; and
connecting with an external electronic device using the identified frequency via a second communication module.

8. The method of claim 7, wherein the AP includes a dynamic frequency selection (DFS) function, and
wherein the frequency used for the communication with the AP by the first communication module is a frequency of a dynamic frequency selection (DFS) restricted band.

9. The method of claim 7, wherein the identifying of the frequency used by the first communication module includes:
when connection request information is received from the external electronic device, identifying the frequency used by the first communication module.

10. The method of claim 7, further comprising:
changing the frequency used for the communication with the AP by the first communication module; and
changing a frequency used for communication of the external electronic device by the second communication module depending on the changed frequency.

11. The method of claim 7, wherein the first communication module is a Wi-Fi module.

12. The method of claim 7, wherein the second communication module is a Wi-Fi module, and
wherein the Wi-Fi module is connected with the external electronic device using at least one of Wi-Fi, Ad-hoc, and TDLS.

13. A computer-readable storage medium storing a program for performing a method comprising:
connecting with an access point (AP) via a first communication module;
identifying a frequency used for communication with the AP by the first communication module; and
connecting with an external electronic device using the identified frequency via a second communication module.
